(19) United States
(12) Patent Application Publication
(10) Pub. No.: US 2018/0320964 A1
(43) Pub. Date: Nov. 8, 2018

(54) Method for Separating Gases and Vapors in a Cascading Coolant Horizontal Spray Tower

(71) Applicants: Larry Baxter, Orem, UT (US); Skyler Chamberlain, Provo, UT (US); Kyler Stitt, Lindon, UT (US); David Frankman, Provo, UT (US); Nathan Davis, Bountiful, UT (US)

(72) Inventors: Larry Baxter, Orem, UT (US); Skyler Chamberlain, Provo, UT (US); Kyler Stitt, Lindon, UT (US); David Frankman, Provo, UT (US); Nathan Davis, Bountiful, UT (US)

(21) Appl. No.: 15/588,075

(22) Filed: May 5, 2017

(51) Int. Cl. F25J 3/08; B01D 5/00; B01D 7/02; B01D 7/00; B01D 53/00

(52) U.S. Cl. CPC F25J 3/08; B01D 5/003; B01D 5/009; B01D 5/0075; B01D 7/02; B01D 7/00; F25J 2220/68; F25J 2205/20; F25J 2205/32; F25J 2210/60; F25J 2210/70; F25J 2210/12; F25J 2220/66; B01D 53/002

(57) ABSTRACT

A process for separating a gas and a vapor is disclosed. A cross-flow horizontal spray vessel comprising horizontally-situated sections is provided. Each of the sections comprise a spray nozzle or nozzles, and a collection hopper. A carrier gas, comprising a product vapor, is passed through the sections. A contact liquid is provided through the spray nozzle or nozzles such that the carrier gas passes across the contact liquid and a portion of the product vapor desublimates, condenses, crystallizes, or combinations thereof as a product solid into the contact liquid, leaving a product-depleted carrier gas. The contact liquid and the product solid are passed to a next preceding upstream spray nozzle or nozzles such that a temperature profile is established across the sections by the contact liquids, as the contact liquids are progressively warmer. The contact liquid and the product solid are removed. The product-depleted carrier gas is removed.

This invention was made with government support under DE-FE0028697 awarded by The Department of Energy. The government has certain rights in the invention.

### FIELD OF THE INVENTION

This invention relates generally to gas/vapor separation. More particularly, we are interested in using horizontal cross-flow spray towers for gas/vapor separation with a phase change.

### BACKGROUND

The use of spray towers to accomplish heat and material exchange is of great use in many industries. Spray towers can be used to remove solids from a carrier gas, to cool a gas, to condense vapors out of gases as liquids, or to desublimate vapors out of gases as solids. While cross-flow horizontal spray towers are taught against in the art compared to countercurrent designs, countercurrent spray towers have unique problems with the last case—desublimation of vapors as solids. Cross-flow horizontal spray towers are not as efficient, liquid droplets are entrained from section to section, and contact time is reduced, but solids produced in cross-flow spray towers do not cascade downward into the next section and coat sprayers, resulting in blocked sprayers, as they do in countercurrent spray towers. However, cross-flow horizontal spray towers are still not as efficient as could be desired. A cross-flow horizontal spray tower with increased efficiency is required.

U.S. Pat. No. 4,039,307, to Bondor, teaches a countercurrent flow horizontal spray absorber. A gas is passed through a series of compartments, the compartments being separated by baffles. Each compartment has a spray that contacts the gas as an absorbent. The absorbent collects in the bottom of each compartment and is pumped to the next prior compartment to act as the spray. The present disclosure differs from this prior art disclosure in several ways. This prior art disclosure appears superficially to be a horizontal exchanger, but is rather a series of compartments that each act as vertical exchangers, similar to a vertical spray tower with multiple sections. As such, it is a series of countercurrent exchangers, and is not a cross-flow exchanger. The material being absorbed forms a soluble component in the absorbent, rather than forming a solid. The baffles would become fouled with solid if the present disclosure were used to produce solids. Further, the absorbent is passed through to provide maximum contact between the gas and the absorbent, not to establish an efficient temperature profile across the compartments. This prior art disclosure is pertinent and may benefit from the methods disclosed herein and is hereby incorporated for reference in its entirety for all that it teaches.

U.S. Pat. Nos. 4,343,771 and 4,269,812, to Edwards, et al., teach a horizontal cross-flow scrubber. The horizontal cross-flow gas liquid contactor increases sulfur dioxide removal by decreasing the interfering spray density through employment of a minimum critical spray nozzle spacing, reducing spray droplet collision and coalescence. The present disclosure differs from these prior art disclosures in that these prior art disclosures utilize a common liquid collection chamber and do not have any cascading coolant. These prior art disclosures are pertinent and may benefit from the methods disclosed herein and are hereby incorporated for reference in their entirety for all that they teach.

U.S. Pat. No. 4,948,402, to Davis, teaches a modular air scrubber system. A series of air scrubber units, each with an independent liquid reservoir, can be attached for air scrubbing. The present disclosure differs from this prior art disclosure in that this prior art disclosure utilizes countercurrent scrubbing and recycle of scrubbing liquid to the same unit, with no cascading coolant. This prior art disclosure is pertinent and may benefit from the methods disclosed herein and is hereby incorporated for reference in its entirety for all that it teaches.

### SUMMARY

A process for separating a gas and a vapor is disclosed. A cross-flow horizontal spray vessel comprising horizontally-situated sections is provided. Each of the sections comprise a spray nozzle or nozzles on an upper portion of the vessel, and a collection hopper on a lower portion of the vessel. A carrier gas, the carrier gas comprising a product vapor, is passed through the sections beginning at one end of the vessel. A contact liquid is provided through the spray nozzle or nozzles such that the carrier gas passes across the contact liquid and a portion of the product vapor desublimates, condenses, crystallizes, or combinations thereof as a product solid into the contact liquid, leaving a product-depleted carrier gas. The contact liquid and the product solid are collected in the collection hopper. The contact liquid and the product solid are passed to a next preceding upstream spray nozzle or nozzles such that a temperature profile is established across the sections by the contact liquid, as the contact liquid is progressively warmer, such that essentially complete desublimation, condensation, crystallization, or combinations thereof of the product vapor is accomplished across the sections. The contact liquid and the product solid are removed from a furthermost upstream section as a product slurry. The product-depleted carrier gas is removed from a furthermost downstream section of the vessel. In this manner, the carrier gas and the product vapor are separated.

The temperature profile of the vessel varies less than a counter-current flow vessel temperature profile.

The passing the contact liquid and the product step is accomplished by pumping. A process controller may be provided. The pumping is accomplished by pumps comprising variable speed drives wherein pumping speeds are controlled by the process controller.

Heat exchangers may be provided between the collection hoppers and the next preceding upstream spray nozzle or nozzles, the heat exchangers modifying the temperature profile to increase efficiency of separations. Solid-liquid separation devices may be provided between the collection hoppers and the next preceding upstream spray nozzle or nozzles, the solid-liquid separation devices removing the product solid from the contact liquid.

The product slurry may be separated into a warm contact liquid and a final product solid. The warm contact liquid may be passed through a heat exchanger to produce the contact liquid. The final product solid may be pressurized and melted to produce a final product liquid.

A mist eliminator may be provided to remove any of the contact liquid entrained in the product-depleted carrier gas leaving the vessel. The contact liquid removed by the mist eliminator may be combined with the product slurry.

A recuperative heat exchanger may be provided to warm the product-depleted carrier gas.

The spray nozzle or nozzles may comprise flat-fan nozzles, hollow-cone nozzles, full-cone nozzles, misting nozzles, solid-stream nozzles, atomizing nozzles, rotary jet nozzles, or combinations thereof. The spray nozzle or nozzles may comprise a design capable of allowing solid particulates to pass through the spray nozzle or nozzles of up to 0.25 inch.

The carrier gas may comprise flue gas, syngas, producer gas, natural gas, steam reforming gas, hydrocarbons, light gases, refinery off-gases, organic solvents, water, ammonia, liquid ammonia, or combinations thereof.

The product vapor may comprise carbon dioxide, nitrogen oxide, sulfur dioxide, nitrogen dioxide, sulfur trioxide, hydrogen sulfide, hydrogen cyanide, water, mercury, hydrocarbons, pharmaceuticals, salts, biomass, or combinations thereof.

The contact liquid may comprise 1,1,3-trimethylcyclopentane, 1,4-pentadiene, 1,5-hexadiene, 1-butene, 1-methyl-1-ethylcyclopentane, 1-pentene, 5,3,3,3-tetrafluoropropene, 5,3-dimethyl-1-butene, 5-chloro-1,1,1,2-tetrafluoroethane, 5-methylpentane, 5-methyl-1,4-pentadiene, 5-methyl-1-butene, 5-methyl-1-pentene, 5-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

The contact liquid may comprise any compound or mixture of compounds with a freezing point above a temperature at which the product vapor condenses, desublimates, crystallizes, or a combination thereof.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a Prior Art countercurrent horizontal spray tower.

FIG. 2 shows a method for separating a gas and a vapor.

FIG. 3 shows a method for separating a gas and a vapor.

FIG. 4 shows a cross-flow horizontal spray vessel for separating a gas and a vapor.

FIG. 5 shows a cross-flow horizontal spray vessel for separating a gas and a vapor.

FIGS. 6A-C show a hollow-cone style nozzle.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

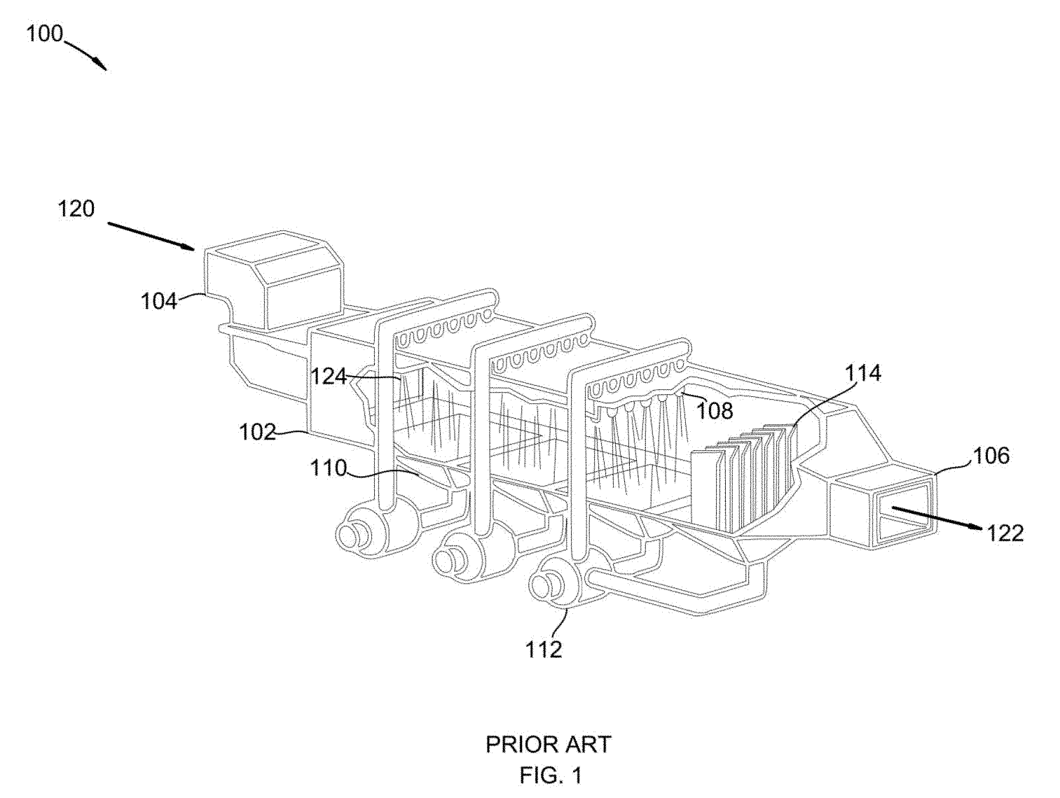

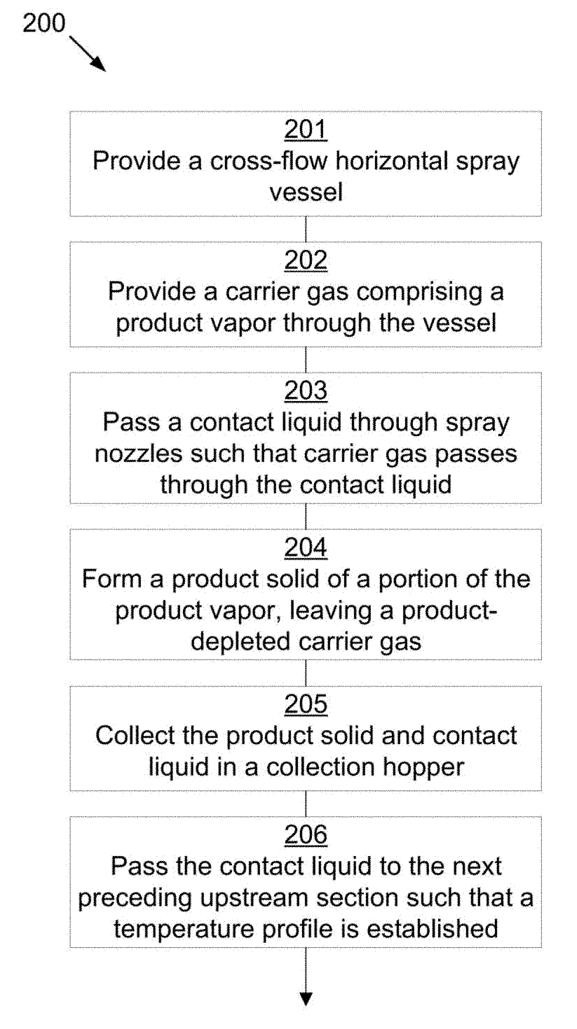

Referring to FIG. 1, a countercurrent horizontal spray tower is shown, as per the Prior Art. Horizontal spray tower 102 is provided with carrier gas 120 and contact liquid 124. Contact liquid 124 is recirculated from collection hoppers 110 and pumped through pumps 112 to spray nozzles 108, where it is sprayed and carrier gas 120 passes through contact liquid 124. Each of collection hoppers 110, pumps 112, and spray nozzles 108 recirculate contact liquid 124 through the same section repeatedly. Carrier gas 124 passes through mist eliminator 114 and out of horizontal spray tower 102. The contact liquid is not cascaded nor is a temperature profile instituted for efficiency of heat, mass, or heat and mass exchange.

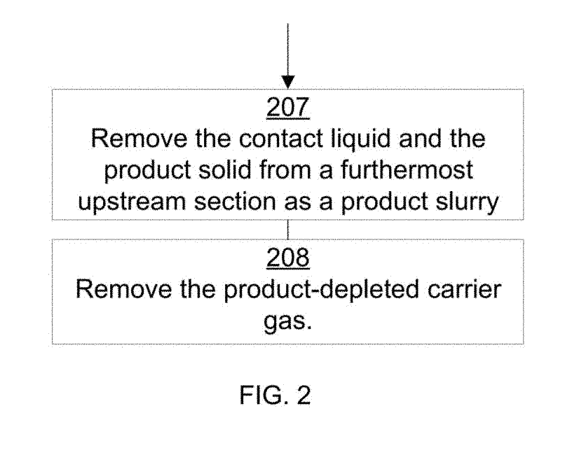

Referring to FIG. 2, a method for separating a gas and a vapor is shown at 200, as per one embodiment of the present invention. A cross-flow horizontal spray vessel comprising horizontally-situated sections is provided 201. Each of the sections comprise a spray nozzle or nozzles on an upper portion of the vessel, and a collection hopper on a lower portion of the vessel. A carrier gas, comprising a product vapor, is passed through the sections beginning at one end of the vessel 202. A contact liquid is provided through the spray nozzle or nozzles such that the carrier gas passes across the contact liquid 203. A portion of the product vapor desublimates, condenses, crystallizes, or combinations thereof as a product solid into the contact liquid, leaving a product-depleted carrier gas 204. The contact liquid and the product solid collect in the collection hopper 205. The contact liquid and the product solid are passed to a next preceding upstream spray nozzle or nozzles such that a temperature profile is established across the sections by the contact liquids, as the contact liquids are progressively warmer, such that essentially complete desublimation, condensation, crystallization, or combinations thereof of the product vapor is accomplished across the sections 206. This temperature profile is established to maximize the efficiency of the heat and mass exchange process. The contact liquid and the product solid are removed from a furthermost upstream section as a product slurry 207. The product-depleted carrier gas is removed from a furthermost downstream section of the vessel 208. In this manner, the carrier gas and the product vapor are separated.

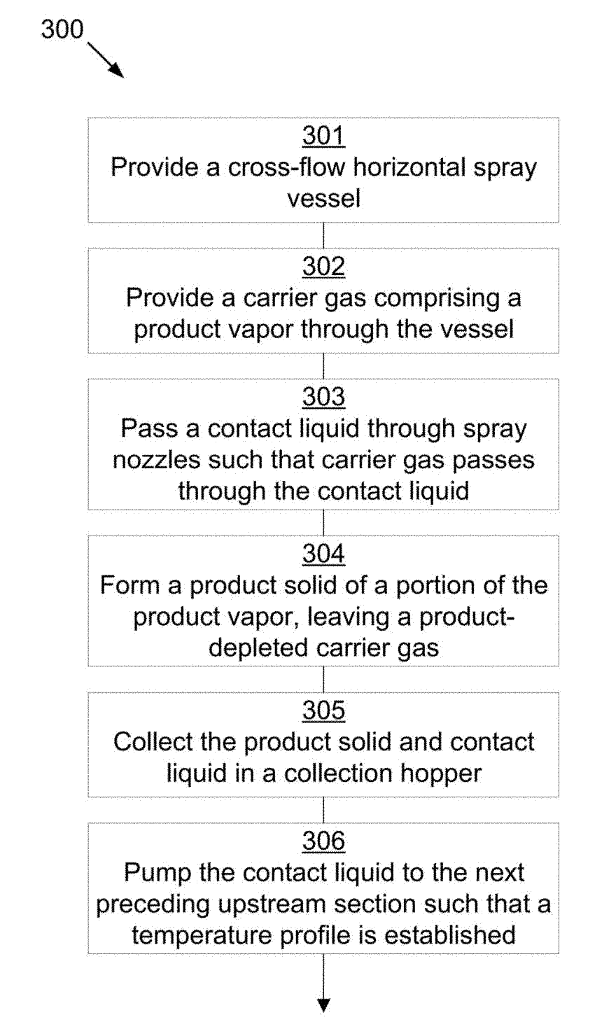

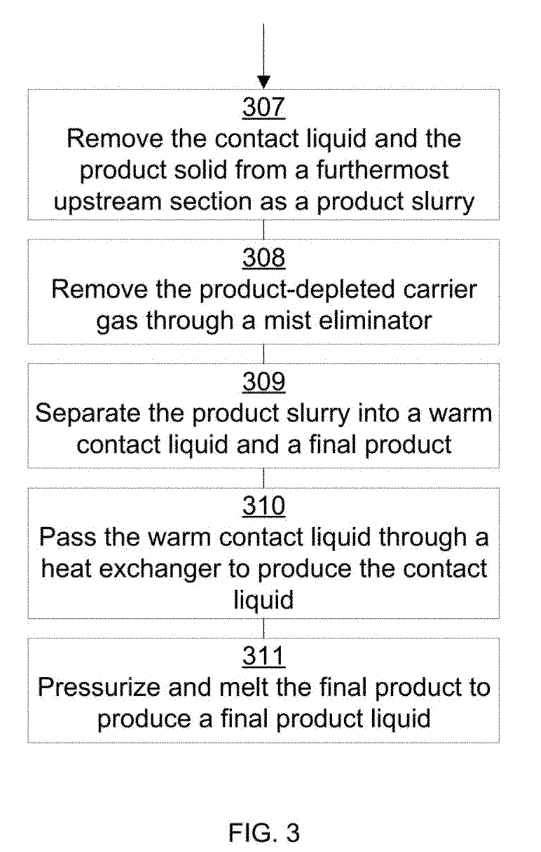

Referring to FIG. 3, a method for separating a gas and a vapor is shown at 300, as per one embodiment of the present invention. A cross-flow horizontal spray vessel comprising horizontally-situated sections is provided 301. Each of the sections comprise a spray nozzle or nozzles on an upper portion of the vessel, and a collection hopper on a lower portion of the vessel. A carrier gas, comprising a product vapor, is passed through the sections beginning at one end of the vessel 302. A contact liquid is provided through the spray nozzle or nozzles such that the carrier gas passes across the contact liquid 303. A portion of the product vapor desublimates, condenses, crystallizes, or combinations thereof as a product solid into the contact liquid, leaving a product-depleted carrier gas 304. The contact liquid and the product solid collect in the collection hopper 305. The contact liquid and the product solid are pumped to a next preceding upstream spray nozzle or nozzles such that a temperature profile is established across the sections by the contact liquids, as the contact liquids are progressively warmer, such that essentially complete desublimation, condensation, crystallization, or combinations thereof of the product vapor is accomplished across the sections 306. This temperature profile is established to maximize the efficiency of the heat and mass exchange process. The contact liquid and the product solid are removed from a furthermost upstream section as a product slurry 307. The product-depleted carrier gas is removed from a furthermost downstream section of the vessel through a mist eliminator 308. The product slurry is separated into a warm contact liquid and a final product 309. The warm contact liquid is passed through a heat exchanger to produce the contact liquid 310. The final product is pressurized and melted to produce a final product liquid 311.

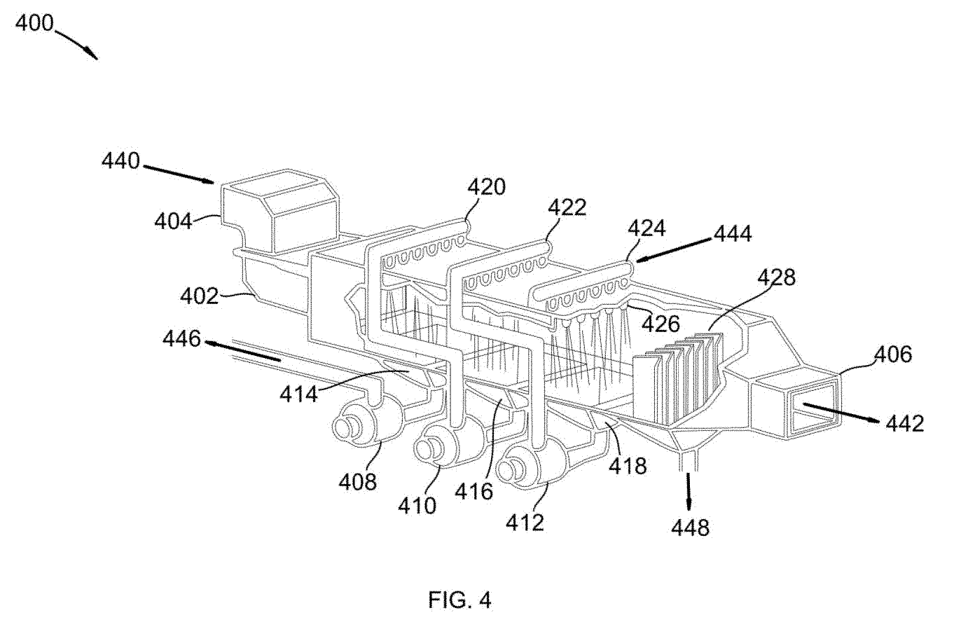

Referring to FIG. 4, a cross-flow horizontal spray vessel for separating a gas and a vapor is shown at 400, as per one embodiment of the present invention. Cross-flow horizontal spray vessel 402 is provided comprising gas inlet 404, gas outlet 406, mist eliminator 428, and three sections. Each section comprises a pump, 408, 410, and 412, a collection hopper, 414, 416, and 418, and a spray nozzle bank, 420, 422, and 424. Each spray nozzle bank comprises six spray nozzles 426. Carrier gas 440, comprising a product vapor, enters vessel 402 through gas inlet 404. Contact liquid 444 enters vessel 402 by passing through spray nozzle bank 424 and passes through nozzles 426 into the third section, forming a spray which collects in collection hopper 418. Contact liquid 444 is pumped by pump 412 through nozzle bank 422 and nozzles 426 into the second section, again forming a spray which collects in collection hopper 416. Contact liquid 444 is pumped by pump 410 through nozzle bank 420 and nozzles 426 into the first section, again forming a spray which collects in collection hopper 414. Carrier gas 440 passes through each of these sections in order, from first through third, and contact liquid 444 in each section causes a portion of the product vapor to desublimate, condense, crystallize, or combinations thereof as a product solid into the contact liquid. The product solid also collects in the collection hoppers 414, 416, and 418 and are pumped with the contact liquid. The first section contact liquid and product solid, product slurry 446, is pumped by pump 408 out of vessel 402. Carrier gas 440 becomes product-depleted carrier gas 442, which is passed through mist eliminator 428 and out of gas outlet 406. Any contact liquid captured in mist eliminator 428 leaves as contact liquid 448.

In some embodiments, product slurry 446 is separated into a warm contact liquid and a final product. The warm contact liquid is combined with contact liquid 448 and is passed through a heat exchanger to produce contact liquid 444. The final product is pressurized and melted to produce a final product liquid.

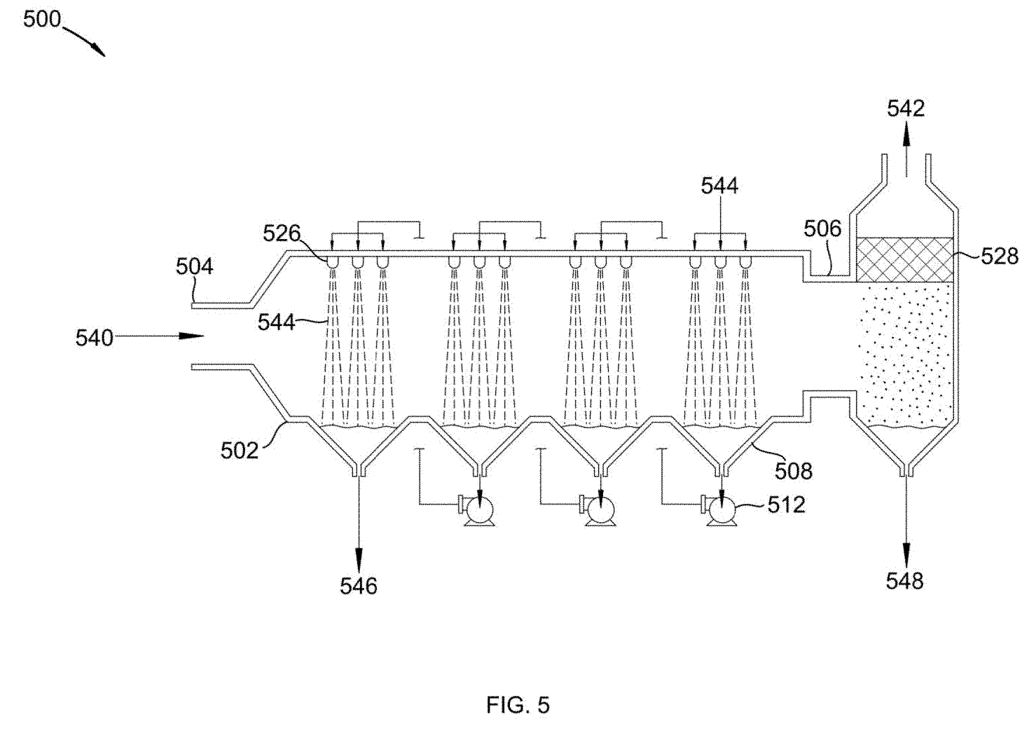

Referring to FIG. 5, a cross-flow horizontal spray vessel for separating a gas and a vapor is shown at 500, as per one embodiment of the present invention. Cross-flow horizontal spray vessel 502 comprises horizontally-situated sections. Each of the sections comprises spray nozzles 526 on an upper portion of vessel 502, and collection hopper 508 on a lower portion of vessel 502. Carrier gas 540, comprising a product vapor, is passed through the sections beginning at gas inlet 504. Contact liquid 544 is provided through spray nozzles 526 such that carrier gas 540 passes across contact liquid 544 and a portion of the product vapor desublimates, condenses, crystallizes, or combinations thereof as a product solid into contact liquid 544, leaving product-depleted carrier gas 542. Contact liquid 544 and the product solid collect in collection hoppers 508. Contact liquid 544 and the product solid are pumped by pumps 512 to next preceding upstream spray nozzles 526 such that a temperature profile is established across the sections by contact liquid 544, as contact liquid 544 is progressively warmer, such that essentially complete desublimation, condensation, crystallization, or combinations thereof of the product vapor is accomplished across the sections. Contact liquid 544 and the product solid is removed from the furthermost upstream section as a product slurry 546. Product-depleted carrier gas 542 is passed out of vessel 502 through gas outlet 506 and mist eliminator 528. Any contact liquid captured in mist eliminator 528 leaves as contact liquid 548.

In some embodiments, product slurry 546 is separated into a warm contact liquid and a final product. The warm contact liquid is combined with contact liquid 548 and is passed through a heat exchanger to produce contact liquid 544. The final product is pressurized and melted to produce a final product liquid.

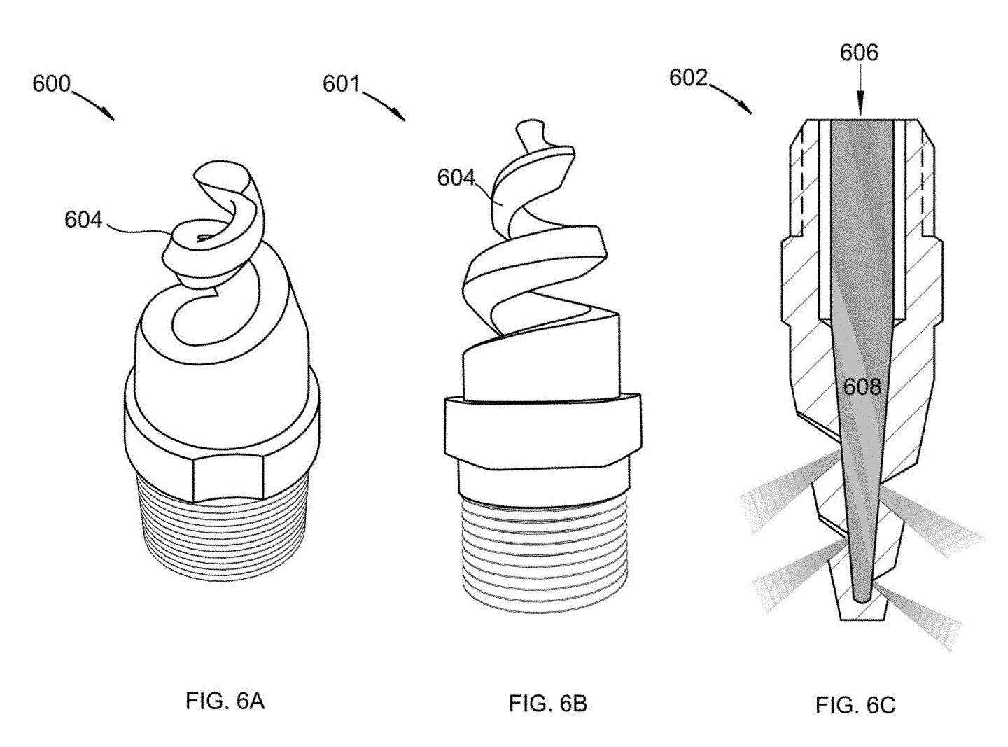

Referring to FIGS. 6A-C, a hollow-cone style nozzle is shown at 600, 601, and 602, as per one embodiment of the present invention. FIG. 6A shows a top-side view of the hollow-cone style nozzle at 600. FIG. 6B shows a side view of the hollow-cone style nozzle at 601. FIG. 6C shows a cross-sectional view of the hollow-cone style nozzle at 602. Contact liquid 606 enters the nozzle and forms spiral flow pattern 608 due to the spirals 604 of the outlet, resulting in spray pattern 608. This style of nozzle passes solids smaller than the spiral openings without becoming clogged, which allows passage of solids between sections of the present invention.

In some embodiments, the temperature profile of the vessel varies less than a counter-current flow vessel temperature profile. This minimization of variation provides a useful increase in efficiency.

In some embodiments, a process controller is provided. In some embodiments, the pumping is accomplished by pumps comprising variable speed drives wherein pumping speeds are controlled by the process controller.

In some embodiments, heat exchangers are provided between the collection hoppers and the next preceding upstream spray nozzle or nozzles, the heat exchangers modifying the temperature profile to increase efficiency of separations. In some embodiments, solid-liquid separation devices are provided between the collection hoppers and the next preceding upstream spray nozzle or nozzles, the solid-liquid separation devices removing the product solid from the contact liquid.

In some embodiments, a recuperative heat exchanger is provided to warm the product-depleted carrier gas.

In some embodiments, the spray nozzle or nozzles comprise flat-fan nozzles, hollow-cone nozzles, full-cone nozzles, misting nozzles, solid-stream nozzles, atomizing nozzles, rotary-jet nozzles, or combinations thereof.

In some embodiments, the carrier gas comprises flue gas, syngas, producer gas, natural gas, steam reforming gas, hydrocarbons, light gases, refinery off-gases, organic solvents, water, ammonia, liquid ammonia, or combinations thereof.

In some embodiments, the product vapor comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, salts, biomass, or combinations thereof.

In some embodiments, the contact liquid comprises 1,1,3-trimethylcyclopentane, 1,4-pentadiene, 1,5-hexadiene, 1-butene, 1-methyl-1-ethylcyclopentane, 1-pentene, 5,3,3,3-tetrafluoropropene, 5,3-dimethyl-1-butene, 5-chloro-1,1,1,2-tetrafluoroethane, 5-methylpentane, 5-methyl-1,4-pentadiene, 5-methyl-1-butene, 5-methyl-1-pentene, 5-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, methanol, ethanol, 1-propanol, 2-propanol, aqueous mixtures thereof, or combinations thereof.

In some embodiments, the contact liquid comprises any compound or mixture of compounds with a freezing point above a temperature at which the product vapor condenses, desublimates, crystallizes, or a combination thereof.

1. A process for separating a gas and a vapor comprising:
providing a cross-flow horizontal spray vessel comprising horizontally-situated sections, each of the sections comprising a spray nozzle or nozzles on an upper portion of the vessel, and a collection hopper on a lower portion of the vessel;
passing a carrier gas, the carrier gas comprising a product vapor, through the sections beginning at one end of the vessel;
providing a contact liquid through the spray nozzle or nozzles such that the carrier gas passes across the contact liquid and a portion of the product vapor desublimates, condenses, crystallizes, or combinations thereof as a product solid into the contact liquid, leaving a product-depleted carrier gas;
collecting the contact liquid and the product solid in the collection hopper;
passing the contact liquid and the product solid to a next preceding upstream spray nozzle or nozzles such that a temperature profile is established across the sections by the contact liquid, as the contact liquid is progressively warmer, such that essentially complete desublimation, condensation, crystallization, or combinations thereof of the product vapor is accomplished across the sections;
removing the contact liquid and the product solid from a furthermost upstream section as a product slurry;
removing the product-depleted carrier gas from a furthermost downstream section of the vessel;
whereby the carrier gas and the product vapor are separated.

2. The process of claim 1, wherein the temperature profile of the vessel varies less than a counter-current flow vessel temperature profile.

3. The process of claim 1, wherein the passing the contact liquid and the product step is accomplished by pumping.

4. The process of claim 3, further comprising providing a process controller.

5. The process of claim 4, wherein the pumping is accomplished by pumps comprising variable speed drives wherein pumping speeds are controlled by the process controller.

6. The process of claim 3, further comprising providing heat exchangers between the collection hoppers and the next preceding upstream spray nozzle or nozzles, the heat exchangers modifying the temperature profile to increase efficiency of separations.

7. The process of claim 3, further comprising providing solid-liquid separation devices between the collection hoppers and the next preceding upstream spray nozzle or nozzles, the solid-liquid separation devices removing the product solid from the contact liquid.

8. The process of claim 7, further comprising providing heat exchangers between the solid-liquid separation devices and the next preceding upstream spray nozzle or nozzles, the heat exchangers modifying the temperature profile to increase efficiency of separations.

9. The process of claim 1, further comprising separating the product slurry into a warm contact liquid and a final product solid.

10. The process of claim 9, further comprising passing the warm contact liquid through a heat exchanger to produce the contact liquid.

11. The process of claim 10, further comprising pressurizing and melting the final product solid to produce a final product liquid.

12. The process of claim 1, further comprising providing a mist eliminator to remove any of the contact liquid entrained in the product-depleted carrier gas leaving the vessel.

13. The process of claim 12, further comprising passing the contact liquid removed by the mist eliminator to combine with the product slurry.

14. The process of claim 1, further comprising providing a recuperative heat exchanger to warm the product-depleted carrier gas.

15. The process of claim 1, providing the spray nozzle or nozzles comprising flat-fan nozzles, hollow-cone nozzles, full-cone nozzles, misting nozzles, solid-stream nozzles, atomizing nozzles, rotary jet nozzles, or combinations thereof.

16. The process of claim 1, providing the spray nozzle or nozzles comprising a design capable of allowing solid particulates to pass through the spray nozzle or nozzles of up to 0.25 inch.

17. The process of claim 1, providing the carrier gas comprising flue gas, syngas, producer gas, natural gas, steam reforming gas, hydrocarbons, light gases, refinery off-gases, organic solvents, water, ammonia, liquid ammonia, or combinations thereof.

18. The process of claim 17, providing the product vapor comprising carbon dioxide, nitrogen oxide, sulfur dioxide, nitrogen dioxide, sulfur trioxide, hydrogen sulfide, hydrogen cyanide, water, mercury, hydrocarbons, pharmaceuticals, salts, biomass, or combinations thereof.

19. The process of claim 18, providing the contact liquid further comprising 1,1,3-trimethylcyclopentane, 1,4-pentadiene, 1,5-hexadiene, 1-butene, 1-methyl-1-ethylcyclopentane, 1-pentene, 5,3,3,3-tetrafluoropropene, 5,3-dimethyl-1-butene, 5-chloro-1,1,1,2-tetrafluoroethane, 5-methylpentane, 5-methyl-1,4-pentadiene, 5-methyl-1-butene, 5-methyl-1-pentene, 5-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, methanol, ethanol, 1-propanol, 2-propanol, aqueous mixtures thereof, or combinations thereof.

20. The process of claim 1, providing the contact liquid comprising any compound or mixture of compounds with a freezing point above a temperature at which the product vapor condenses, desublimates, crystallizes, or a combination thereof.
